(19) United States
(12) Patent Application Publication
(10) Pub. No.: US 2015/0074774 A1
(43) Pub. Date: Mar. 12, 2015

(54) System, apparatus, and method for a unified identity wallet

(71) Applicant: Dhana Systems Corp., San Jose, CA (US)

(72) Inventors: Prashant Nema, San Jose, CA (US); Iris Hit-Shagir, Sunnyvale, CA (US)

(21) Appl. No.: 14/081,575

(22) Filed: Nov. 15, 2013

Related U.S. Application Data
(60) Provisional application No. 61/875,637, filed on Sep. 9, 2013.

(51) Int. Cl. H04L 29/06

(52) U.S. Cl. CPC H04L 63/08
USPC 726/5

(57) ABSTRACT

A unified identity wallet system, for allowing a user to manage online digital authentication, authorization, and access rights in a simple and secure manner, can include a unified identity wallet server, a pass repository, a unified identity wallet app, an access authorization app, and a unified identity pass manager. The unified identify wallet app can include a processor, a non-transitory memory, an input/output component, a wallet store, a pass requester, and an access manager. A pass provides access authorization to a user and can include the identity of receiver, purpose, type of locations, usage modes, and periods of validity; and can be translated to and stored in a variety of different mobile wallet formats. Further described are a computer-implemented method for obtaining or renewing a pass, and a computer-implemented method for obtaining access to a system.

### CROSS-REFERENCE TO RELATED APPLICATIONS

This application claims the benefit of U.S. Provisional Application No. 61/875,637, filed Sep. 9, 2013.

### FIELD OF THE INVENTION

The present invention relates generally to the field of identity and credential authentication, and more specifically to the concept of digital identity wallets, which refers to an electronic device or software application that allows an individual to conduct commerce, transact payments, share information, and authenticate access in online and offline settings.

### BACKGROUND OF THE INVENTION

Authentication is the act of confirming the identity of an object or entity. This might involve confirming the identity of a person or software program, tracing the origins of an artifact, or ensuring that a product is what its packaging and labeling claims it to be. Authentication often involves verifying the validity of at least one form of identification.

The ways in which someone may be authenticated fall into three general categories, known as the factors of authentication: something the user knows, something the user has, and something the user is. Each authentication factor covers a range of elements used to authenticate or verify a person's identity prior to being granted some form of access or authority

The process of authorization is distinct from that of authentication. Whereas authentication is the process of verifying that “you are who you say you are”, authorization is the process of verifying that “you are permitted to do what you are trying to do” i.e. access a system, access a room or car, access a club or event, permit to do a transaction etc. Authorization therefore requires prior authentication.

The process of authentication, has a number of well-known issues, including:
a. Users may store access credentials in a sheet or document, which if compromised provides access to identity and other authentication information;
b. Users may synchronize all passwords and use a common password, which if compromised provides access to all systems;
c. Users may use a tool, such as a password manager, but still are forced to keep track of the creation of new accounts and passwords, reset/renew the credentials, and then ensure the password manager is updated accordingly;
d. Every time the user is creating another account, by adding a new username/password combination, this is associated with an expanding digital identity presence and consequent increased exposure to fraud.
e. One-time passwords on hardware keys, such as a RSA hardware token, are cumbersome for consumers to carry. They also impose significant cost overheads for issuers, such as banks, and have been adopted slowly by online service providers.
f. One-time passwords issued via SMS, which is transmitted and shared over the carriers open network, have proved insecure by multiple scenarios of compromise worldwide
g. Enterprises do not have the flexibility and control over which users use what authentication method for what factor and for what transaction, system and geography.

Due to these complexities and cost-overheads, many online authentication systems still rely only on single factor authentication. At the same time, intelligent devices, including buildings with various forms of electronic keys, are becoming ubiquitous, forcing consumers to carry an increasing number of special keys, and maintain an ever-growing list of passwords.

Digital wallets, meaning applications or devices, that can confirm identity, authenticate access, and process payment transactions, aim to address some of these problems, but will generally restrict the user to the particular wallet format that is supported by the digital wallet. A user may therefore have to install or carry an increasing number of different digital wallets.

As such, it may be appreciated that there continues to be a need for novel and improved methods and devices for management of authentication and authorization, covering both software applications and physical devices and systems.

### SUMMARY OF THE INVENTION

The foregoing needs are met, to a great extent, by the present invention, wherein in aspects of the unified identity wallet, enhancements are provided to the existing models for digital wallets, authentication, and authorization.

Aspects of the invention allow a person to use and manage their mobile digital authentication, commerce, transaction, authorization, and access rights in a simple and secure manner, by using a unified identity wallet, containing a plurality of passes authorizing access to specific systems.

Various aspects of the invention create the opportunity for users to utilize their mobile devices to access all of their accounts and mobile applications in a secure manner with one simple sign-on, and without the need for passwords. This single sign-on capability enables safe management for all of user's identities and privileges in one place. This can for example cover access to online accounts, such as financial and healthcare accounts, as well as access to physical devices and systems, such as vehicles and buildings.

In a related aspect, the unified identity wallet can communicate, mediate, consolidate, manage and secure a user's other digital wallets.

In an aspect, a unified identity wallet system can include: a unified identity wallet server, a pass repository, a unified identity wallet app, an access authorization app, and a unified identity pass manager, which can allow a user to obtain a pass, which is issued by an issuer and stored in the pass repository by the unified identity wallet server, so the user can further employ this pass to obtain access, via the access authorization app, to a system.

In an related aspect, a unified identity wallet app can include: a processor, a memory, an input/output component, a wallet store, a pass requester, an access manager, so that the pass requester can obtain a pass from the unified identity wallet server, store the pass locally in the wallet store, so that the access manager can retrieve the pass from the wallet store, and communicate with access authorization app.

In a related aspect, the unified identity wallet server can function as a mobile wallet middleware layer, which can integrate and unify the operations of third-party digital wallets, enterprises and systems, including for example payment, authentication, and identification systems.

In a further related aspect, an enterprise issuer can connect to third party mobile wallets, their own mobile wallets, such as bank owned wallets when the issuer is a bank, or to white label mobile wallets, issued by the unified identity wallet system, as used by other third-party enterprise issuers.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram illustrating the unified identity wallet system, according to an embodiment of the invention.

FIG. 2 is a schematic diagram illustrating the unified identity wallet app, according to an embodiment of the invention.

FIG. 3 is a schematic diagram illustrating the unified identity pass manager, according to an embodiment of the invention.

FIG. 4 is a schematic diagram illustrating the access authorization app, according to an embodiment of the invention.

FIG. 5 is a schematic diagram illustrating the unified identity wallet server, according to an embodiment of the invention.

FIG. 6 is a flowchart illustrating steps that can be followed, in accordance with one embodiment of the method or process of requesting a pass.

FIG. 7 is a flowchart illustrating steps that can be followed, in accordance with one embodiment of the method or process of using a pass to gain access to a system.

### DETAILED DESCRIPTION

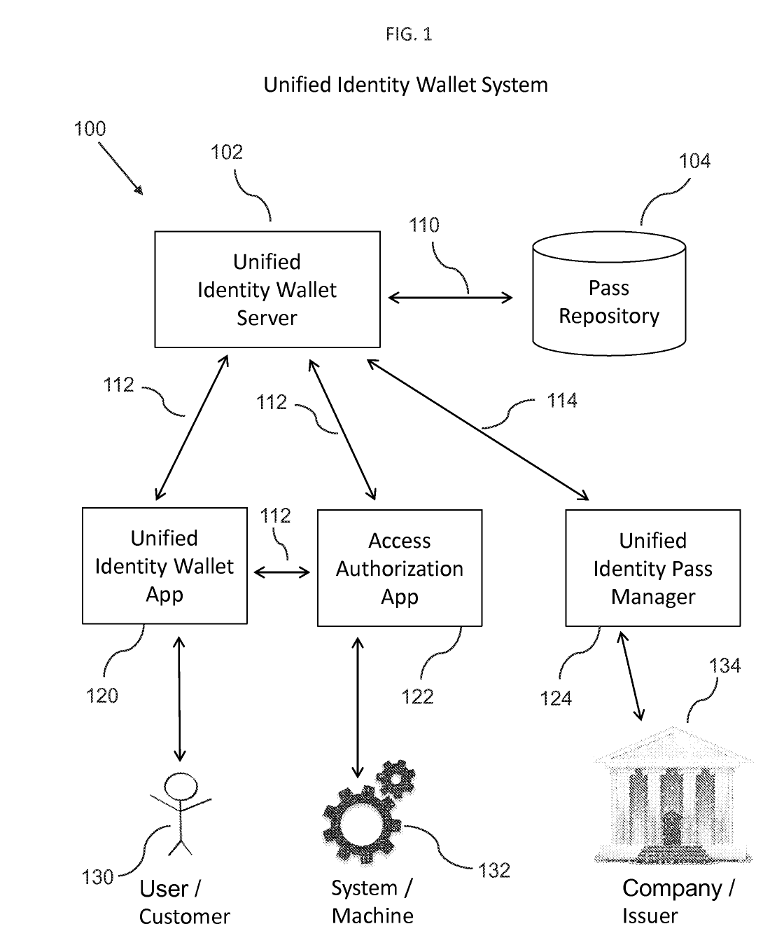

In the following, we describe the structure of an embodiment of the unified identity wallet system 100 with reference to FIG. 1, in such manner that like reference numerals refer to like components throughout; a convention that we shall employ for the remainder of this specification.

In an embodiment, a unified identity wallet system 100 can include:
a. A unified identity wallet server 102,
b. A pass repository 104,
c. A unified identity wallet app 120,
d. An access authorization app 122, and
e. A unified identity pass manager 124,
   Wherein a user 130, can obtain a pass, which is issued by an issuer 134, and stored in the pass repository 104 by the unified identity wallet server 102, and wherein the user can further employ this pass to obtain access, via the access authorization app 122, to a system 132.

In a related embodiment, the unified identity wallet server 102 and the pass repository 104 can reside within the same logical or physical system component. Particularly, the pass repository 104 can be a component of the unified identity wallet server 102.

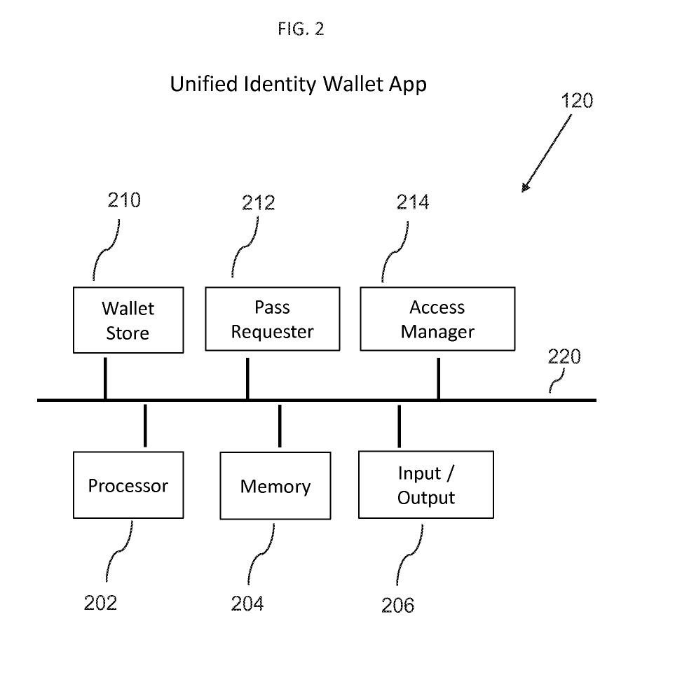

In an embodiment, illustrated in FIG. 2, a unified identity wallet app 120 can include:
a. A processor 202,
b. A memory 204,
c. An input/output component 206,
d. A wallet store 210,
e. A pass requester 212, and
f. An access manager 214, with all components connected via
g. A data bus 220;
   wherein the pass requester 212 can obtain a pass, from the unified identity wallet server 102, store the pass locally in the wallet store 210, so that the access manager 214, can retrieve the pass from the wallet store 210, and communicate with access authorization app 122, following access information and actions provided in the pass, in order to obtain access to the system 132.

In a further related embodiment, if the access manager 214 fails to find a pass in the wallet store 210, to fulfill a request for access to the system 132, it can request a new or renewed pass from the pass requester 212.

In a related embodiment, a pass can be a:
a. digital pass—a standard structure of information fields in a secure form to serve a purpose
b. identity pass—a digital pass with the user's identity embedded in it as well. This ensures that a specific pass can only be used by the user whose identity is embedded in the pass.
c. wallet pass—a digital pass (or identity pass) which is translated to a specific proprietary or standard mobile wallet format, such as for example Apple passbook or Google wallet, to be compliant to store and use in that wallet

In a related embodiment, a pass can be active if it has been created by the unified identity wallet server 102, is in a issued state, not expired and valid, and ready for use in the wallet store 210 of a user's 130 unified identity wallet app 120.

In a further related embodiment, the access provided by the access manager 214, can include a broad range of logical access, permission, and authority, including social access or connectedness, as well as physical access to systems, structures, buildings. For example, the access could be:
a. membership privilege to a society or an organization, or a meeting;
b. access to a personal car, vehicle, boat, or other transportation device;
c. access to a building or other physical facility;
d. an electronic boarding pass, to access an airplane or other means of transportation;
e. access to a payment system;
f. mobile commerce privileges, such as coupons, offers, loyalty cards.

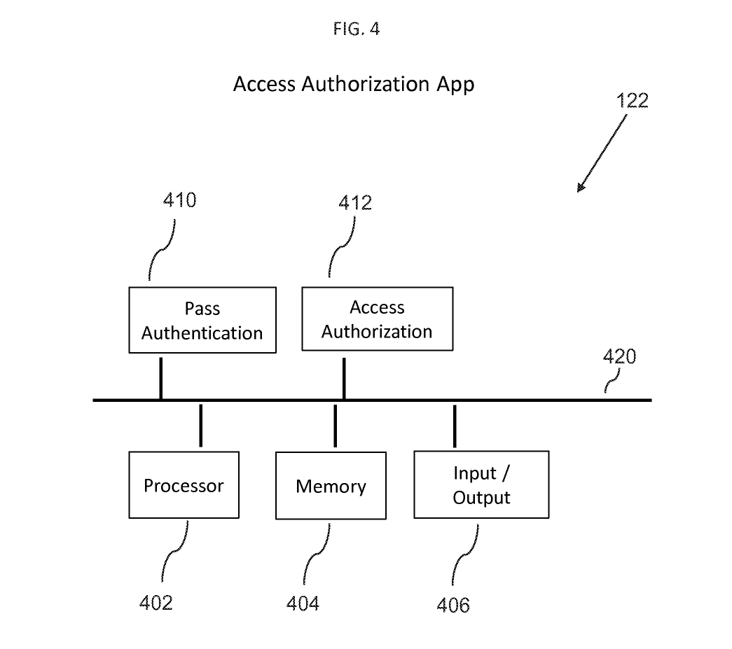

In an embodiment, as illustrated in FIG. 4, an access authorization app 122 can include:
a. A processor 402,
b. A memory 404,
c. An input/output component 406,
d. A pass authentication component 410, and
e. An access authorization component 412, with all components connected via
f. A data bus 420;
   wherein the pass authentication component 410, can be configured to authenticate a pass provided by the unified wallet app 120, and the access authorization component 412, using information in the pass, can be configured to access the system 132.

In a related embodiment, a pass can be:
a. Digitally issued independently by the issuer 134;
b. Stored safely in the pass repository 104;
c. Delivered to the customer/user 130, when requested on the chosen device in the wallet;
d. Stored safely and correctly in the wallet store 210 of the unified identity wallet app 120;
e. and subsequently used by the issuer 134 and/or user 130 when system access is requested anywhere by the issuer/user 130 to provide valid authentication and authorization, for access to the system 132, via respectively the pass authentication component 410 and access authorization component 412 of the access authorization app 122.

It shall be furthermore understood that an executing instance of the embodiment of the unified identity wallet system 100, as shown in FIG. 1, can include a plurality of separate identity wallet apps 120, which are each tied to one or more users 130, wherein each identity wallet app 120 can store passes allowing access to a plurality of third party mobile wallets.

An executing instance of the embodiment of the unified identity wallet system 100, as shown in FIG. 1, can similarly include a plurality of access authorizations apps 122, unified identity wallet servers 102, pass repositories 104, and unified identity pass managers 124.

In a related embodiment, the pass repository 104 can include:
a. A generic pass database, which is a database of all passes handled by the unified identity wallet server 102. All pass data is stored here as a database record in a standard record format schema model; and
b. A native pass database, which is a database of all active passes in the unified identity wallet server 102. All pass data is held here in the native form of the mobile wallet it was created for, and all records have a link to the corresponding unique record in the generic pass database.

In a further related embodiment, both the identity wallet app 120 and the access authorization app 122 can each respectively operate as standalone connected components, or they can be embedded within other external applications, systems, or business solutions. The access authorization app 122 can for example be a web browser plug-in, providing access to web based email, electronic banking, and other online services; or it could be an embedded component operating within a vehicle control system in a car.

In a further related embodiment, the identity wallet app 120 and the access authorization app 122 can be configured to operate as one component, which can operate as a stand-alone connected component, or can be embedded within other external applications, systems, or business solutions.

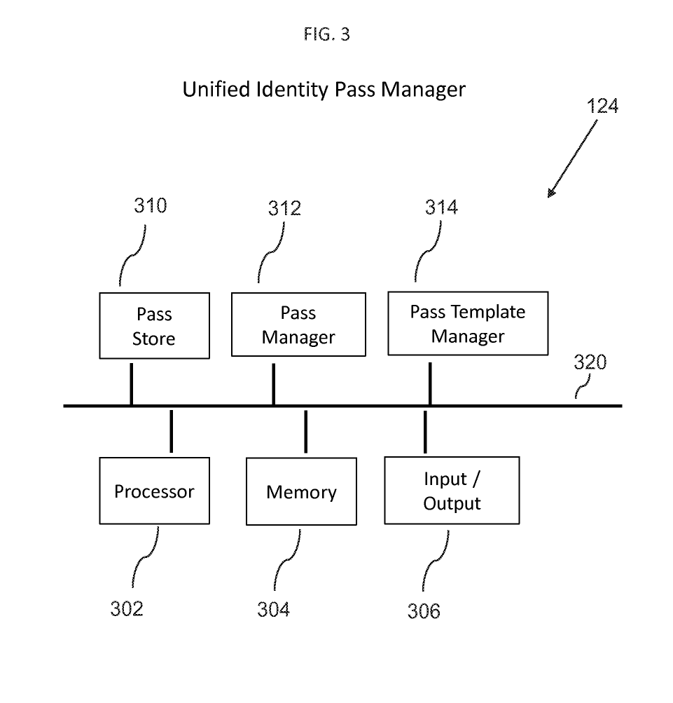

In a related embodiment, as shown in FIG. 3, a unified identity pass manager 124 can include:
a. A processor 302;
b. A memory 304;
c. An input/output component 306;
d. A pass store 310;
e. A pass template manager 314; and
f. A pass manager 312; with all components connected via
g. A data bus 320;
   Wherein the pass manager 312 can be configured to manage the creation, allocation, renewal, and deletion, of passes in communication with the unified identity wallet server 102, based on generic pass templates received and stored by the pass template manager 314; and the pass store 310 can be configured to store passes locally, and in the pass repository 104, via communication with the unified identity wallet server 102.

Related example embodiments can be:
a. a bank defining the access for its users, across a plurality of channels, to the banks systems;
b. an airline issuing tickets and boarding passes to its users;
c. an event organizer issuing tickets to events;
d. a home protection or access system, which can issue home access passes to the owner, family, etc.

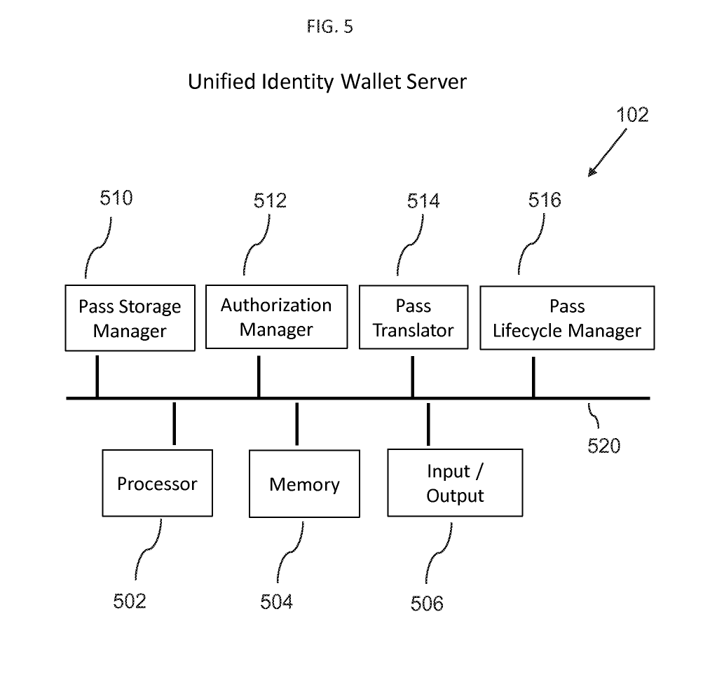

In a related embodiment illustrated in FIG. 5, A unified identity wallet server 102 can include:
a. A processor 502;
b. A memory 504;
c. An input/output component 506;
d. A pass storage manager 510;
e. An authorization manager 512;
f. A pass translator 514; and
g. A pass lifecycle manager 516; with all components connected via
h. A databus 520;
   Wherein
   the authorization manager 512 can be configured to authenticate and authorize requests from either the unified identity wallet app 120, or the access authorization app 122;
   the pass storage manager 510, can be configured to process the requests, including storing, retrieving and physically or logically deleting passes stored in the pass repository 104;
   the pass translator 514 can be configured to create, translate, and store, a pass in the specific format of the users mobile wallet format; and
   the pass lifecycle manager 516 can be configured to manage the transport and storage of passes between the unified identity wallet server 102 and the unified identity wallet app 120.

FIG. 1 shows a depiction of an embodiment of the unified identity wallet system 100, including the unified identity wallet server 102, and the pass repository 104. In this relation, a server shall be understood to represent a general computing capability that can be physically manifested as one, two, or a plurality of individual physical computing devices, located at one or several physical locations. A server can for example be manifested as a shared computational use of one single desktop computer, a dedicated server, a cluster of rack-mounted physical servers, a datacenter, or network of datacenters, each such datacenter containing a plurality of physical servers, or a computing cloud, such as Amazon EC2 or Microsoft Azure.

It shall be understood that the above-mentioned components of the unified identity wallet app 120, the access authorization app 122, the unified identity pass manager 124, and the unified identity wallet server 102 are to be interpreted in the most general manner.

For example, the processor 202, the processor 302, the processor 402, and the processor 502, can each respectively include a single physical microprocessor or microcontroller, a cluster of processors, a datacenter or a cluster of datacenters, a computing cloud service, and the like.

In a further example, the memory 204, the memory 304, the memory 404, and the memory 504, can each respectively include various forms of non-transitory storage media, including random access memory and other forms of dynamic storage, and hard disks, hard disk clusters, cloud storage services, and other forms of long-term storage. Similarly, the input/output 206 and the input/output 306 can each respectively include a plurality of well-known input/output devices, such as screens, keyboards, pointing devices, motion trackers, communication ports, and so forth, and can further communicate via a plurality of network protocols, including Ethernet, TCP/IP, Wi-Fi, Bluetooth, ZigBee, NFC, etc.

Furthermore, it shall be understood that the unified identity wallet server 102, the unified identity wallet app 120, the access authorization app 122, and the unified identity pass manager 124, can each respectively include a number of other components that are well known in the art of general computer devices, and therefore shall not be further described herein. This can include system access to common functions and hardware, such as for example via operating system layers such as Windows, Linux, and similar operating system software, but can also include configurations wherein application services are executing directly on server hardware or via a hardware abstraction layer other than a complete operating system.

In related embodiments, the unified identity wallet server 102, the unified identity wallet app 120, the access authorization app 122, and the unified identity pass manager 124, can each respectively be part of a general computer, such as a personal computer (PC), a tablet, a notebook, a laptop, a workstation, a server, a mainframe computer, a smart phone, a mobile device, a smart television, an embedded processor in a vehicle, machine, or building structure, a similar device, or some combination of these. Such a general computer can include a memory, a processor, input/out components, and other components that are common for general computers, all of which are well known in the art and therefore will not be further elaborated or described herein.

Additionally, in an embodiment of the unified identity wallet system 100, both the unified identity wallet app 120 and the unified identity pass manager 124; each respectively executing in a computational environment, such as for example a web browser or a general computer; can communicate information to the user and request user input by way of an interactive, menu-driven, visual display-based user interface, or graphical user interface (GUI). The user interface can be executed, for example, on a smartphone with a touch sensitive screen, and screen based keyboard, with which the user may interactively input information using direct manipulation of the GUI. Direct manipulation can include the use of a pointing device, such as a mouse, a stylus, or a touch sensitive screen, to select from a variety of selectable fields, including selectable menus, drop-down menus, tabs, buttons, bullets, checkboxes, text boxes, and the like. Nevertheless, various embodiments of the unified identity system may incorporate any number of additional functional user interface schemes in place of this interface scheme, with or without the use of a mouse or buttons or keys, including for example, a trackball, a touch screen, a voice-activated system, or a biometric input system, such as fingerprint, eye scan, or voice print authentication systems.

In a related embodiment, the unified identity wallet app 120 communicates with the unified identity wallet server 102 over a network 112, which can include the general Internet, a Wide Area Network or a Local Area Network, or another form of communication network, transmitted on wired or wireless connections. Wireless networks can for example include Ethernet, Wi-Fi, Bluetooth, ZigBee, and NFC. The communication can be transferred via a secure, encrypted communication protocol.

In a related embodiment, the access authorization app 122 communicates with the unified identity wallet server 102 over a network 112, which can include the general Internet, a Wide Area Network or a Local Area Network, or another form of communication network, transmitted on wired or wireless connections. Such communication networks can for example include Ethernet, Wi-Fi, Bluetooth, ZigBee, and NFC. The communication can be transferred via a secure, encrypted communication protocol.

In a related embodiment, the unified identity wallet app 120 communicates with the access authorization app 122 over the network 112, which can be the general Internet, a Wide Area Network or a Local Area Network, or another form of communication network, transmitted on wired or wireless connections. Such communication networks can for example include Ethernet, Wi-Fi, Bluetooth, ZigBee, and NFC. The communication can be transferred via a secure, encrypted communication protocol.

In a related embodiment, the unified identity pass manager 124 communicates with the unified identity wallet server 102 over the network 114, which can be the general Internet, a Wide Area Network or a Local Area Network, or another form of communication network, transmitted on wired or wireless connections. Such communication networks can for example include Ethernet, Wi-Fi, Bluetooth, ZigBee, and NFC. The communication can be transferred via a secure, encrypted communication protocol. In some cases, the network 114 may further include a virtual or physical private network.

In related embodiments, the unified identity wallet app 120 can include a:
a. Web application, executing in a Web browser;
b. a tablet app, executing on a tablet device, such as for example an Android or iOS tablet device;
c. a mobile app, executing on a mobile device, such as for example an Android phone or iPhone, or any wearable mobile device;
d. a desktop application, executing on a personal computer, or similar device;
e. an embedded application, executing on a processing device, for example in a vehicle, an automated teller machine, or other systems.

In various embodiments, the unified identity wallet system 100 can create the opportunity for users to utilize their mobile devices to safely access all of their accounts and mobile applications with one simple sign-on and optionally without the need for passwords. This single sign-on capability enables safe management for all of a user's identities and privileges, such as for example access to financial and healthcare accounts, in one place.

In a further related embodiment, the unified identity wallet system 100 can consolidate, manage and secure a user's other digital wallets, which are provided via other third party systems.

In related embodiments, the unified identity wallet system 100 can:
a. Protect privileged accounts
b. Secure wallets for identity passes
c. Eliminate the need to store passwords
d. Provide an access privilege to a digital asset via a pass
e. Allow a bank to control the issuance of passes for bank systems
f. Maintain synchronization between the identity wallet server and identity wallet devices
g. Work in offline mode

In a related embodiment, every instance of a unified identity wallet app 120 is associated with one unique user, identified by a unique user id.

In a further related embodiment, the wallet, stored in the wallet store 210, can create an implicit automatic federation between the user id associated with the wallet, and all the user id's in the passes that are contained in the wallet

In a related embodiment, every instance of an integrated device identity wallet app 120 can contain one identity wallet, stored in the wallet store component 210, which stores the passes associated with a user 130.

In a further related embodiment, an instance of an integrated device identity wallet app 120 can contain multiple identity wallets, each stored in the wallet store component 210, wherein each identity wallet stores passes associated with a respective user 130, wherein the respective user 130 can obtain access to the specific identity wallet associated with his or her user id.

In related embodiments, a pass can include some or all of the following components:
a. Identity of User (Who), which describes who can use the pass, and can further comprise:
   i. Identity in issuer system;
   ii. Identity in identity wallet;
   iii. Subscriber Identity.
b. Purpose (What), which denotes for what purpose the pass is issued, and can further comprise:
   i. Issuer information, including
      1. Business name;
      2. Legal entity type;
      3. Issuer system; such as for example mobile banking, retail outlet, flight ticketing, etc.;
   ii. Business purpose and transaction type, such as for example login, fund transfer, or purchase;
c. Locations Type (Where), which describes what online and offline locations the pass is valid for, and can further comprise:
   i. Which stores is this pass valid for discount
   ii. Which branches of the bank can I use ATM
   iii. Which geographies can I use my DMV identity
   iv. valid devices where pass is valid;
   v. which websites, will accept payment using the pass;
   vi. which home or car is this key valid for;
   vii. proximity distance from the asset in purpose to access;
d. Usage mode (How), which describes how the pass should be used, or which methods the pass will use for authentication, wherein options can include:
   i. Protocol of access enabled—WIFI, online, in store;
   ii. Channels of access, such as for example web, mobile, ATM, offline, etc.;
   iii. Authorization level, which can describe the level of access provided.
   iv. Device Type, including biometric authentication devices, such as a finger print sensor, or an iris scanner;
e. Time/Day/Validity (When), which specifies the period of validity of the pass, including the days of the week for which the pass is valid, the date of expiration, etc.

In a related embodiment, every pass can protect access to an issuer's digital asset, such as for example a mobile banking system.

In a related embodiment, each pass can allow the unified wallet app 120 user 130 to prove back his or her identity to the issuer.

In relation to the following, a companion app shall be understood to mean an enterprise mobile application on the consumer's smartphone that has the ability to interface and access the specific format passes in the mobile wallet(s) on the same consumer smartphone. For example, an American Airlines mobile app can interface with an American Airlines boarding pass in the Apple passbook, a Bank of America mobile application can interface with the Bank of America credit card pass in the Google wallet.

In related embodiments, the unified identity wallet server 102 can function as a mobile wallet middleware layer, which can serve a plurality of functions in integrating and unifying the operations of third-party enterprises and systems, including for example payment, authentication, and identification systems, wherein the plurality of functions can include:
a. Provide an open middleware layer that can allow any enterprise interested in mobile commerce to rapidly connect with their consumers, who are using a plurality of different mobile wallet formats;
b. Provide an open middleware layer that can interface with all open mobile wallet standards via their published APIs
c. Provide a simple GUI or API interface to customer enterprise employees and systems;
d. Allow an enterprise issuer 134 to connect to third party mobile wallets, their own mobile wallets, such as bank owned wallets when the issuer 134 is a bank, or to white label mobile wallets, issued by the unified identity wallet system, as used by other third-party enterprise issuers 134.
e. Provide management functions for the issuer 134 enterprise customer, including:
   i. design passes;
   ii. monitor consumer usage of their passes;
   which can allow the enterprise customer to instantly be active and publish new passes to mobile wallets.
f. Provide middleware APIs to design, publish and monitor of the consumer passes in mobile wallets, which can for example be employed by more technically advanced enterpriser customers 134;
g. Provide functionality to profile, manage, monitor and measure the usage by each associated issuer 134 enterprise customer for passes, users, redeems, wallet types, etc.;
h. Provide functionality that can be accessed globally, to support international issuers 134, and support international inter-bank transactions.;
i. Provide a high-security, high-reliability, and high-integrity solution for pass transactions, while retaining near-instant response performance.

In related embodiments, the unified identity wallet server 102, or mobile wallet middleware, can be logically divided in 4 layers:
a. A business purpose layer, wherein an issuer 134 enterprise business employee can engage to decide and select the purpose of the user 130 engagement via the mobile wallet, including:
   i. What, which specifies what the issuer 134 wants to offer, or do with your customers/consumers, such as for example: offer, membership, etc.;
   ii. How, which specifies how the issuer 134 wants this offer or action to work, such as for example: online, offline, for what user groups, frequency, etc.;
   iii. Where—which specifies which stores, branches, web sites, locations, geographies the service should work for;
   iv. When—which specifies the time or duration, such as for example one-time use only, or multiple-time use, every weekend, every day, is available for next 30 days, or only between 9-5 on weekdays;
b. A pass creation layer, wherein an issuer 134 enterprise business employee can select templates to define a pass and store it in the pass repository, wherein the pass definition can further include:
   i. Branding, such as externally visible logos, company names, key visible pieces of pass data;
   ii. Skin, such as externally visible thumbnails, backgrounds, pictures, strips, or any other visual effects;
   iii. Pass data, such as the internal data of the pass/ticket that will be stored and updated;
   iv. Find or search functions, or APIs, to find passes in the generic pass database of the pass repository 104;
c. An identity pass creation layer, wherein an issuer 134 enterprise business employee can for passes marked to be identity passes, can tokenize and stamp the specific end target users 130 identity into the general pass already created in the pass database, so that further
   i. An identity verification API in the identity pass creation layer can be used by other layers or functions in the unified identity waller server 102, or by the issuer enterprise 134 directly, to verify the identity of a user 130. Identity verification can for example include personal, social, and government identity verification;
   ii. The identity tokenization can be done via an end user profile stored in the pass repository 104, or the wallet store 210, or sent via API in profile data. Identity tokens can be updated according to a pre-determined schedule, for example every day (default), every hour, or any other suitable frequency;
   iii. The user and his device and/or mobile wallet can be tethered to validate the right user to the pass. The end user 130 mobile wallet could be identified as a specific users wallet or could be user agnostic, and may be tethered to the device bound to the user;
   iv. On updates to the pass during its lifecycle, notification can be sent to the specific user who has the pass, for example for general offers, or is the owner of the pass for example to issue identity or membership cards;
d. A wallet pass handling layer, wherein the pass, retrieved from the generic pass database, is translated and created in the specific format of the end users 130 chosen mobile wallet format, before being distributed or updated to the mobile wallet. In this layer other wallet types from third party wallet providers can be integrated and provided as alternative wallet format options. The wallet pass handling layer can further include:
   i. A specific mobile wallet pass translator 514 that can be called via specific internal APIs to create and store the mobile wallet format passes in the native format here, such as for example .PKPASS for Passbook, in the native pass database;
   ii. A distribution engine that can deliver the pass via the mobile wallets supported or augmented by various delivery mechanisms, such as email, sms, APIs, web, companion app, etc.
   iii. An update engine that can use the specific wallet translators as passes get redeemed or change state (as decided by the creator enterprise 134) and stored again in the native pass database.

In a related embodiment, the identity wallet app 120 can be configured to store a pass in the wallet store 210, in the specific format of an end users 130 chosen wallet format.

In a related embodiment, the access authorization app 122 can be configured to process a pass in the specific format of an end users 130 chosen wallet format, via access authorization app 412 to obtain access to a system 132.

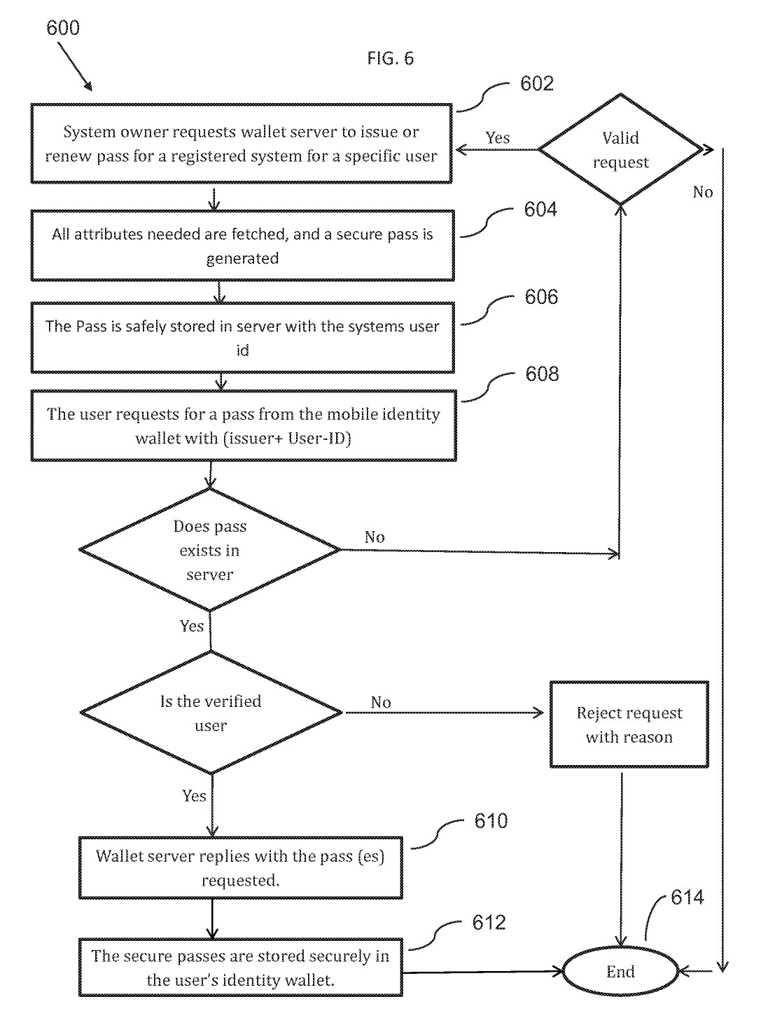

In a related embodiment, illustrated in FIG. 6, a method for obtaining or renewing a pass can comprise:
a. Requesting a pass 602, wherein a system owner from an issuer requests a wallet server to issue or renew a pass for a registered system for a specific user;
b. Generating a pass 604, wherein all attributes needed are fetched from the wallet server, and a secure pass is generated;
c. Storing the pass 606, wherein the pass is stored in the wallet server with the registered system's user id;
d. Requesting a pass 608, wherein the user requests for a pass from the mobile identity wallet specifying the issuer and user id; and further
   i. If the pass does not exist on the server and the request is valid, proceeding to requesting a pass 602; or
   ii. If the pass does not exist on the server and the request is not valid, proceeding to termination 614 of the method; or
   iii. If the pass exist and the user is not verified, issuing a rejection with reason, and then proceeding to termination the method 614; or
   iv. If the pass exist and the user is verified, continuing the method
e. Providing a pass 610, wherein the wallet server replies with the pass or passes requested;
f. Storing the pass 612, wherein the pass or passes are stored securely in the user's identity wallet;
g. Terminating the method 614.

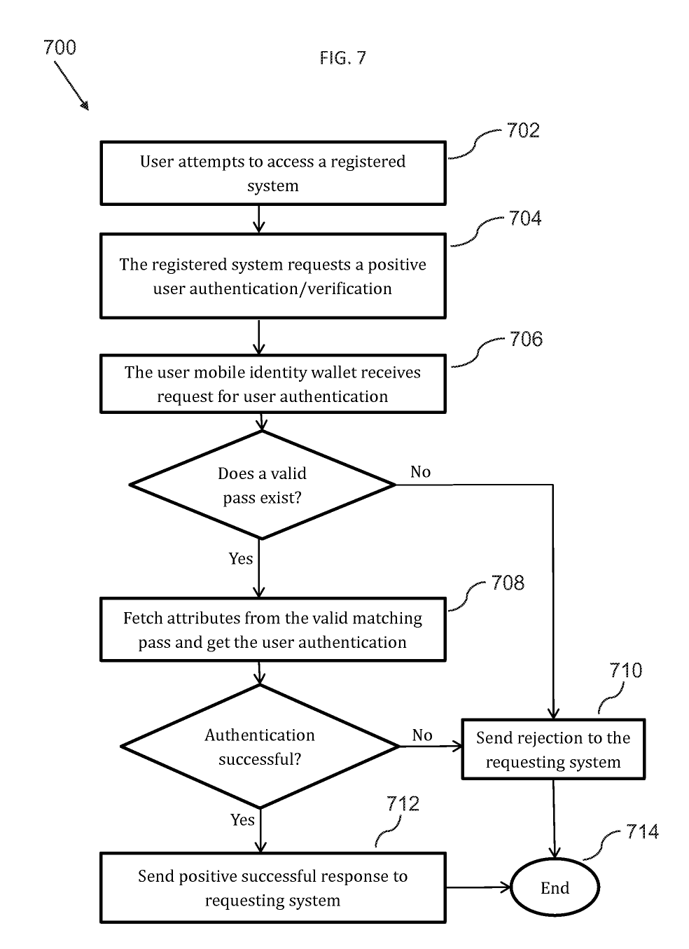

In a related embodiment, illustrated in FIG. 7, a method for obtaining access to a system can comprise:
a. Requesting access 702, wherein a user attempts to access a registered system;
b. Requesting authentication 704, wherein the registered system requests a positive authentication of the user;
c. Receiving authentication request 706, wherein the user's identity wallet receives the request for user authentication, and further
   i. If a valid pass does not exist, proceeding to send rejection 710, wherein the identity wallet sends a rejection to the requesting system, and proceeds to terminating the method 714; or
   ii. If a valid pass does exist, continuing;
d. Sending positive response 712, wherein a positive successful response is sent to the requesting system;
e. Terminating the method 714.

FIGS. 1, 2, 3, 4, 5, 6, and 7 are block diagrams and flowcharts methods, devices, systems, apparatuses, and computer program products according to various embodiments of the present invention. It shall be understood that each block or step of the block diagram, flowchart and control flow illustrations, and combinations of blocks in the block diagram, flowchart and control flow illustrations, can be implemented by computer program instructions or other means. Although computer program instructions are discussed, an apparatus or system according to the present invention can include other means, such as hardware or some combination of hardware and software, including one or more processors or controllers, for performing the disclosed functions.

In this regard, FIGS. 2, 3, 4 and 5 depict the computer devices of various embodiments, each containing several of the key components of a general-purpose computer by which an embodiment of the present invention may be implemented. Those of ordinary skill in the art will appreciate that a computer can include many components. However, it is not necessary that all of these generally conventional components be shown in order to disclose an illustrative embodiment for practicing the invention. The general-purpose computer can include a processing unit and a system memory, which may include random access memory (RAM) and read-only memory (ROM). The computer also may include nonvolatile storage memory, such as a hard disk drive, where additional data can be stored.

An embodiment of the present invention can also include one or more input or output components, such as a mouse, keyboard, monitor, and the like. A display can be provided for viewing text and graphical data, as well as a user interface to allow a user to request specific operations. Furthermore, an embodiment of the present invention may be connected to one or more remote computers via a network interface. The connection may be over a local area network (LAN) wide area network (WAN), and can include all of the necessary circuitry for such a connection.

Typically, computer program instructions may be loaded onto the computer or other general-purpose programmable machine to produce a specialized machine, such that the instructions that execute on the computer or other programmable machine create means for implementing the functions specified in the block diagrams, schematic diagrams or flowcharts. Such computer program instructions may also be stored in a computer-readable medium that when loaded into a computer or other programmable machine can direct the machine to function in a particular manner, such that the instructions stored in the computer-readable medium produce an article of manufacture including instruction means that implement the function specified in the block diagrams, schematic diagrams or flowcharts.

In addition, the computer program instructions may be loaded into a computer or other programmable machine to cause a series of operational steps to be performed by the computer or other programmable machine to produce a computer-implemented process, such that the instructions that execute on the computer or other programmable machine provide steps for implementing the functions specified in the block diagram, schematic diagram, flowchart block or step.

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagrams, schematic diagrams or flowcharts, as well as combinations of blocks or steps, can be implemented by special purpose hardware-based computer systems, or combinations of special purpose hardware and computer instructions, that perform the specified functions or steps.

As an example, provided for purposes of illustration only, a data input software tool of a search engine application can be a representative means for receiving a query including one or more search terms. Similar software tools of applications, or implementations of embodiments of the present invention, can be means for performing the specified functions. For example, an embodiment of the present invention may include computer software for interfacing a processing element with a user-controlled input device, such as a mouse, keyboard, touch screen display, scanner, or the like. Similarly, an output of an embodiment of the present invention may include, for example, a combination of display software, video card hardware, and display hardware. A processing element may include, for example, a controller or microprocessor, such as a central processing unit (CPU), arithmetic logic unit (ALU), or control unit.

In this specification and the appended claims, the singular forms “a,” “an,” and “the” include plural reference unless the context clearly dictates otherwise. Thus, for example, a reference to “an element” is a reference to one or more elements and includes equivalents thereof known to those skilled in the art. Similarly, in another example, a reference to “a step” or “a means” is a reference to one or more steps or means and may include substeps and subservient means. Similarly, in a further example, a reference to “a component”, is a reference to one or more components, wherein the plurality of components can for example be object instances derived from a general component class.

In this specification and the appended claims, all conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

The many features and advantages of the invention are apparent from the detailed specification, and thus, it is intended by the appended claims to cover all such features and advantages of the invention, which fall within the true spirit and scope of the invention.

Many such alternative configurations are readily apparent, and should be considered to be fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention.

What is claimed is:

1. A unified identity wallet system for managing online digital authentication, authorization, transaction and access, for a user, in a simple and secure manner, comprising:
a. a unified identity wallet server; and
b. a pass repository;
wherein the unified identity wallet server is configured to process passes that are stored and retrieved from the pass repository.

2. The unified identity wallet system of claim 1, further comprising a unified identity pass manager, wherein the unified identity pass manager can create, process, and delete passes, the passes can be stored and retrieved from the unified identity wallet server, and the unified identity wallet server further stores the passes in the pass repository.

3. The unified identity wallet system of claim 1, further comprising a unified identity wallet app, wherein the unified identity wallet app is configured to process a pass retrieved from the unified identity wallet server, and can further store the pass locally in a wallet store.

4. The unified identity wallet system of claim 3, further comprising an access authorization app, wherein the access authorization app is configured to receive a pass from the unified identity wallet app, and process this pass, using information contained in the pass, in order to authenticate and/or authorize access to a system.

5. The unified identity wallet system of claim 1, wherein the unified identity wallet server further comprises a pass translator, which can store, translate and create a pass in the specific format of the users mobile wallet format.

6. The unified identity wallet system of claim 1, wherein the unified identity wallet app is associated with only one user, identified by a unique user identity.

7. The unified identity wallet system of claim 1, wherein the unified identity wallet app is associated with a plurality of users, each identified by a respective unique user id.

8. The unified identity wallet system of claim 1, wherein a pass further comprises:
a. identity of user, wherein the pass specifies who can use the pass;
b. purpose, wherein the pass specifies for what purpose the pass is issued;
c. location type, wherein the pass specifies which online and offline locations the pass is valid for;
d. usage mode, wherein the pass specifies how the pass should be used, and which methods the pass can use for authentication; and
e. validity, wherein the pass specifies the period of validity of the pass.

9. A unified identity wallet app, comprising:
a. a processor;
b. a memory;
c. an input/output; and
d. a wallet store;
wherein the wallet store is configured to store passes.

10. The unified identity wallet app of claim 9, further comprising a pass requester, wherein the pass requester is configured to store and retrieve a pass in communication with an external unified identity wallet server.

11. The unified identity wallet app of claim 9, further comprising an access manager, wherein the access manager is configured to communicate with an external access authorization app, following access information and actions specified in a pass retrieved from the wallet store, in order to obtain access to a system.

12. The unified identity wallet app of claim 9, wherein a pass in the specific format of the user's mobile wallet format can be stored in the wallet store.

13. The unified identity wallet app of claim 9, wherein the identity wallet app can store only one identity wallet in the wallet store, wherein the identity wallet is associated with a user.

14. The unified identity wallet app of claim 9, wherein the identity wallet app can store a plurality of identity wallets, each respective identity wallet is stored in the wallet store, and each respective identity wallet is associated with a respective user, wherein the respective user can access the respective identity wallet.

15. The unified identity wallet app of claim 9, wherein the identity wallet, stored in the wallet store, is configured to establish an implicit automatic federation between the user id associated with the identity wallet, and all the user ids in the passes that are contained in the identity wallet.

16. The unified identity wallet app of claim 9, wherein a pass further comprises:
a. identity of user, wherein the pass specifies who can use the pass;
b. purpose, wherein the pass specifies for what purpose the pass is issued;
c. authentication type, wherein the pass specifies which devices and procedures the pass will use for authentication;
d. usage mode, wherein the pass specifies how the pass should be used; and
e. validity, wherein the pass specifies the period of validity of the pass.

17. The unified identity wallet app of claim 10, wherein the access manager is further configured to request a pass from the pass requester, if it fails to retrieve a pass from the wallet store.

18. The unified identity wallet app of claim 11, further comprising an access authorization app, wherein the access manager is configured to communicate with the access authorization app, following access information and actions specified in a pass retrieved from the wallet store, in order to obtain authorization or access to a system.

19. A computer-implemented method for obtaining a pass, comprising:
a. requesting a pass from a wallet server, wherein a system owner from an issuer requests a wallet server to issue or renew a pass for a registered system for a user;
b. generating a pass, wherein all attributes needed are fetched from the wallet server, and a secure pass is generated by the issuer;
c. storing the pass in the wallet server, wherein the pass is stored in the wallet server with the registered system's user identity.

20. The computer-implemented method for obtaining a pass of claim 19, further comprising:
d. requesting a pass, wherein the user requests for a pass from the mobile identity wallet; and further comprising:
i. if the pass does not exist on the server and the request is valid, proceeding to (a) requesting a pass; or
ii. if the pass does not exist on the server and the request is not valid, proceeding to termination of the method; or
iii. if the pass exist and the user is not verified, issuing a rejection with reason, and then proceeding to termination of the method; or
iv. if the pass exist and the user is verified, continuing the method;
e. providing a pass, wherein the wallet server replies with the pass or passes requested.

21. The computer-implemented method for obtaining a pass of claim 20, further comprising:
f. storing the pass, wherein the pass or passes are stored securely in the user's identity wallet;

22. A computer-implemented method for obtaining access to a system, comprising:
a. requesting access, wherein a user attempts to access a registered system;
b. requesting authentication, wherein the registered system requests a positive authentication of the user;
c. receiving an authentication request, wherein the user's identity wallet receives the request for user authentication;
d. sending a positive response, wherein a positive successful response is sent to the requesting system.

23. The computer-implemented method for obtaining access to a system of claim 22, wherein the user has access to only one identity wallet, which is associated with the user.

24. The computer-implemented method for obtaining access to a system of claim 22, wherein the user has access to a plurality of identity wallets, and each respective identity wallet is associated with a respective user, wherein the respective user can access the respective identity wallet.
